(19) United States
(12) Patent Application Publication
(10) Pub. No.: US 2013/0327015 A1
(43) Pub. Date: Dec. 12, 2013

(54) DUAL USE HYDRAZINE PROPULSION THRUSTER SYSTEM

(71) Applicants: Pamela Pollet, (US); Logan Todd Williams, (US); Charles Leonard Liotta, (US); Mitchell L.R. Walker, (US); Hillary Anne Huttenhower, (US)

(72) Inventors: Pamela Pollet, (US); Logan Todd Williams, (US); Charles Leonard Liotta, (US); Mitchell L.R. Walker, (US); Hillary Anne Huttenhower, (US)

(21) Appl. No.: 13/494,851

(22) Filed: Jun. 12, 2012

(51) Int. Cl. F03H 99/00; F02K 9/00

(52) U.S. Cl. 60/244; 60/204; 60/202

(57) ABSTRACT

Some embodiments provide a dual use hydrazine propulsion thruster system. The dual use hydrazine propulsion thruster system may include a storage vessel configured to store hydrazine and a chemical thruster configured to provide thrust using the hydrazine. The dual use hydrazine propulsion thruster system may also include a convertor configured to catalytically convert hydrazine to a product comprising ammonia, and an electric thruster configured to provide thrust by ionizing ammonia and accelerating the ionized ammonia out of the electric thruster.

### BACKGROUND

1. Field

The embodiments relate to propulsion thrusters such as satellite or rocket thrusters.

2. Description of Related Art

Current satellite thrusters may use chemical or electric propulsion techniques for deployment and station keeping missions. Chemical thrusters typically use a fuel and an oxidizer as propellants (or a fuel only in the case of monopropellant thrusters) and tend to provide higher thrust, resulting in greater acceleration, but lower specific impulse (a measure of how effectively each unit mass of propellant was used for thrust generation, a ratio of the thrust produced to the mass flow of the propellants). Electric thrusters tend to provide lower thrust, resulting in lower spacecraft acceleration, but higher specific impulse. As a result, a chemical thruster may be quick to deploy and change the location of a spacecraft in an orbit due to the greater thrust, but may require a large propellant tank to deliver the same impulse of an electric thruster because of the lower efficiency of the thrust system. Alternatively, an electric thruster may have a long lifetime and require only a small propellant tank, but will be slower to deploy and maneuver the satellite because of the decreased thrust available. The ability to deliver the same impulse with less propellant results in several advantages, however, such as a reduced cost to launch the payload, or an increase in allowable payload, or an increase in satellite or payload operational life, or any combination thereof.

### SUMMARY

The embodiments disclosed herein include propulsion thrusters which may be configured with, for example, two different paths by which hydrazine is used to generate thrust. Under one path, the hydrazine may provide chemical thrust. Under the second path, the hydrazine may be converted to at least one ionic species which may be accelerated out of an electric thruster to generate electric thrust.

In some embodiments, a dual thruster system comprises: a storage vessel configured to store hydrazine; a chemical thruster configured to receive hydrazine from the storage vessel and to provide thrust by a reaction of the hydrazine; a convertor configured to receive hydrazine from the storage vessel, wherein the converter is further configured to catalytically convert hydrazine to a product comprising ammonia; and an electric thruster configured to receive ammonia from the convertor, and to provide thrust by ionizing the ammonia and accelerating the ionized ammonia out of the electric thruster.

In some embodiments, a method of providing both chemical and electric propulsion to a dual mode rocket thruster system comprises: providing chemical propulsion by a reaction of hydrazine; and providing electric propulsion by a process comprising catalytically converting hydrazine to a reaction product comprising ammonia; ionizing the product comprising ammonia; and providing an electric field to provide thrust by accelerating the ionized reaction product from the electric thruster.

### BRIEF DESCRIPTION OF THE DRAWINGS

FIG. 1 includes a general schematic flowchart for some embodiments of a dual use hydrazine propulsion thruster.

FIG. 2 includes a schematic applicable to some embodiments of a dual use hydrazine propulsion thruster.

FIG. 3 includes another schematic applicable to some embodiments of a dual use hydrazine propulsion thruster.

FIG. 4 includes a schematic of some embodiments of an electric thruster.

### DETAILED DESCRIPTION

There is a need for a propulsion system capable of propelling a payload, e.g. a satellite or the like, so that the payload may maneuver rapidly if needed, but be capable of a long duration operational mission life, e.g. maintaining an orbit or the like, while requiring a relatively small amount of propellant compared to a chemical thruster. Example embodiments of such a propulsion system are discussed herein.

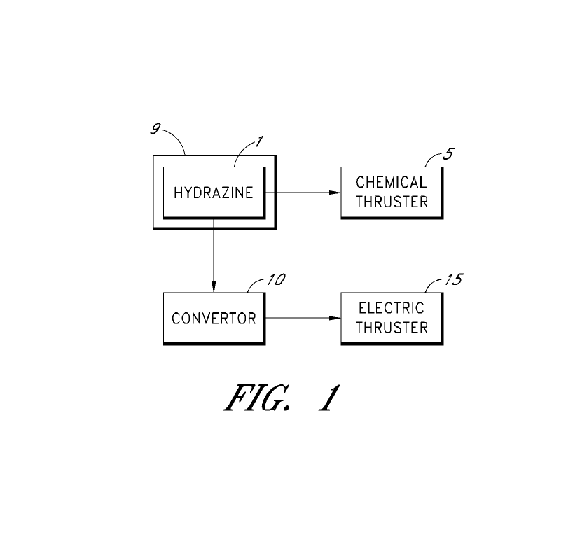

FIG. 1 includes a general schematic flowchart for some embodiments of a dual use hydrazine propulsion thruster. In these embodiments, hydrazine 1 may be provided to a chemical thruster 5 to provide a chemical thrust. The hydrazine may also be provided to a convertor 10, which may convert at least a portion of the provided hydrazine to ammonia. The convertor 10 may then provide at least a portion of the ammonia to an electric thruster 15. The electric thruster 15 may then ionize at least a portion of the ammonia, and the ionized ammonia may then be accelerated out of the thruster to provide electric thrust.

In some embodiments, the hydrazine 1 may be stored in a storage vessel 9, such as a hydrazine tank. The storage vessel 9 may be any vessel that is capable of storing hydrazine. In some embodiments, a storage vessel 9, or tank, may be configured to store hydrazine under pressure. A hydrazine tank may be pressurized, for example, via an external regulated high pressure gas source or as a stand-alone blowdown system where the pressurized gas and the propellant hydrazine 1 are stored in the tank at an initial elevated pressure that decreases over the life of the system as the hydrazine propellant is expended. The pressurizing gas can be any gas that is compatible with the hydrazine 1, e.g. helium, nitrogen, or the like. The hydrazine tank is generally fabricated from a hydrazine-compatible material, e.g. stainless steel, titanium, aluminum or the like. The hydrazine tank and/or the pressurizing gas tank can have a spherical shape, however the tanks can also take the shape of other typical pressure vessels, e.g. a cylinder, a cone, or the like.

In some embodiments, the chemical thruster 5 and the convertor 10 may be configured to receive hydrazine 1 from the storage vessel 9. In some embodiments, one or more conduits, pipes, valves, lumens, channels, tubes, ducts, flex lines, injectors, or any other element capable of delivering liquids or gases, such as cooled or pressurized liquids or gases, from one vessel to another can be provided for delivering hydrazine 1 from the storage vessel 9 to the chemical thruster 5 and the convertor 10. Similarly, one or more conduits, pipes, valves, lumens, channels, tubes, ducts, flex lines, injectors, or any other capable element can be provided for delivering ammonia from the convertor 10 to the electric thruster 15.

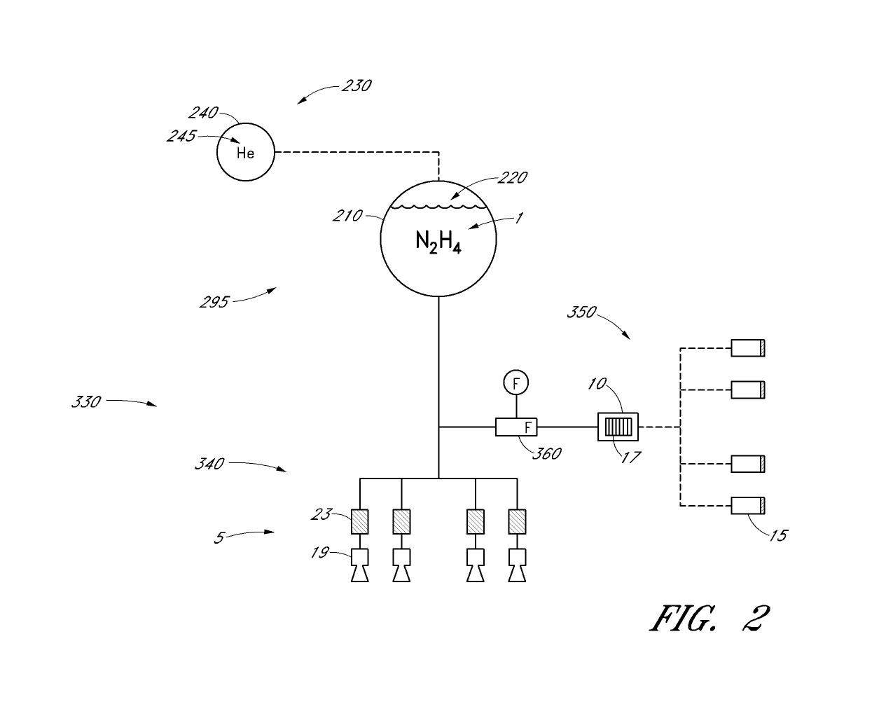

FIG. 2 includes a schematic applicable to some embodiments of a dual use hydrazine propulsion thruster. FIG. 2 includes a hydrazine delivery system 295, a helium pressure system 230, and a thruster system 330, that includes a chemical thruster system 340 and an electric thruster system 350. Components represented in FIG. 2 may be optional, however. Further, additional components can be added in various embodiments. With respect to FIG. 2, a dashed line may represent gas flow between two components, and a solid line may represent liquid flow between components.

The hydrazine delivery system 295 may include hydrazine 1 contained in a pressurized hydrazine tank 210 having a headspace 220 that may be pressurized by a helium pressure system 230. The helium pressure system 230 may comprise a helium tank 240 comprising helium gas 245 in fluid communication with the hydrazine delivery system 295 so that helium gas may flow from the helium tank 240 to the pressurized hydrazine tank 210. The helium gas 245 contained in the helium tank 240 may be a pressure source to the headspace 220 of the hydrazine tank 210. The hydrazine delivery system 295 and the helium pressure system 230 can also include one or more valves, pressure regulators, pressure gauges, conduits, etc. to facilitate and control the flow of, for example, helium to the hydrazine tank 240, and the flow of hydrazine to the chemical thruster system 340 and the electric thruster system 350.

The thruster system 330 may comprise a chemical thruster system 340 and an electric thruster system 350, which may be in fluid communication with one another. The chemical thruster system 340 and the electric thruster system 350 can be of various types, examples of which are discussed herein, depending upon a given application.

The chemical thruster system 340 may comprise at least one chemical thruster 5, but may comprise 2, 3, 4, 5, 6, 7, 8, 9, or 10 or more chemical thrusters 5. A chemical thruster may comprise a catalyst 23 that may be in fluid communication with a thrust chamber 19.

The electric thruster system 350 may comprise a flow controller 360 in-line between the hydrazine tank 210 and the electric thruster(s) 15 (any number of electric thrusters 15 can be used). The electric thruster(s) 15 may require only a small mass of hydrazine, and the flow controller may be sensitive so that it can control a very small flow. For example, the thrust of one of the electric thrusters, part of the electric thrusters, or all of the electric thrusters may be: less than about 10 N, less than about 1 N, less than about 0.5 N, or less than about 0.1 N; and/or may be as low as about 0.01 N, as low as about 0.001N, as low as about 0.0001N, as low as about 0.00001N, or as low as about 0.000001N. The electric thruster system 350 may further comprise the converter 10 in-line between the hydrazine tank 210 or the flow controller 360 and the electric thruster(s) 15. The converter 10 may include a catalyst bed 17. Examples of the converter 10 are discussed further herein.

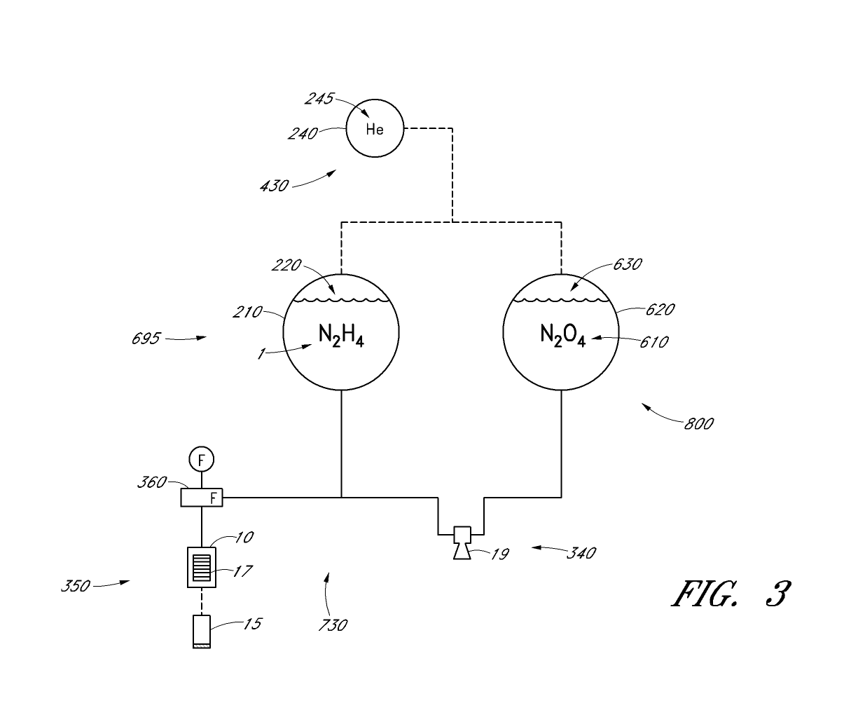

FIG. 3 is another schematic applicable to some embodiments of a dual use hydrazine propulsion thruster that may further comprise an oxidizer, such as N₂O₄, so that the mixture of hydrazine and oxidizer is a hypergolic propellant. FIG. 3 includes a hydrazine delivery system 695, an oxidizer delivery system 800, a helium pressure system 430, and a thruster system 730 that includes a chemical thruster system 340 and an electric thruster system 350. Components represented in FIG. 3 may be optional, however. Further, additional components can be added in various embodiments. With respect to FIG. 3, a dashed line may represent gas flow between two components, and a solid line may represent liquid flow between components.

Hydrazine 1 may be contained in pressurized hydrazine tank 210 having a headspace 220 that may be pressurized by the helium pressure system 430. An oxidizer 610, such as N₂O₄, may be contained in a pressurized oxidizer tank 620 having a headspace 630 that may also be pressurized by the helium pressure system 430. A helium pressure system 430 may comprise a helium tank 240 comprising helium gas 245 in fluid communication with the hydrazine and oxidizer delivery systems so that helium gas may flow from the helium tank 240 to the pressurized hydrazine tank 210 and/or the oxidizer tank 620. The helium gas 245 contained in the helium tank 240 may be the pressure source of the headspace 220 of the hydrazine tank 210 and/or the headspace 630 of the pressurized oxidizer tank 620.

The pressurized hydrazine tank 210 may be part of a hydrazine delivery system 695, and the pressurized oxidizer tank 620 may be part of the oxidizer delivery system 800. The hydrazine delivery system 695, the oxidizer delivery system 800, and the helium pressure system 430 can also include one or more valves, pressure regulators, pressure gauges, conduits, etc. to facilitate and control the flow of, for example, helium to the hydrazine and oxidizer tanks, as well as the flow of hydrazine to the chemical thruster system 340 and the electric thruster system 350.

The thruster system 730 may comprise a chemical thruster system 340 and an electric thruster system 350. The chemical thruster 5 may be configured to provide thrust by exothermically decomposing hydrazine 1. The chemical thruster 5 may further comprise an optional catalyst (as illustrated in FIG. 2), which may facilitate exothermic decomposition of the hydrazine 1 to provide thrust. The electric thruster system 350 may be similar to that described with respect to FIG. 2.

The convertor 10 may be configured to catalytically convert hydrazine to a reaction product comprising ammonia. In some embodiments, the convertor may comprise a plurality of metallic nanoparticles, such as a metallic nanoparticle catalyst bed 17, which may catalytically convert the hydrazine. In some embodiments, at least part of any metallic nanoparticles may comprise a transition metal, such as a Group 6B metal, e.g. chromium, molybdenum, tungsten, etc.; a Group 7B metal, e.g. manganese, technetium, rhenium, etc.; a group 8B metal such as iron, ruthenium, osmium, cobalt, rhodium, iridium, nickel, palladium, platinum, etc.; and the like. In some embodiments, at least part of any metallic nanoparticles comprise at least one of nickel, copper, and iron, such as nano-nickel particles, nano-iron particles, metallic nanoparticles made of several metals (e.g. combinations of two or more of nickel, copper, iron, and other metals), silica-metal nanoparticles such as silica-nickel nanoparticles, silica-iron nanoparticles, etc. In some embodiments, the catalysts or nanoparticles of catalysts may be deposited on supports such as silica, a ceramic, alumina, TiO₂, etc., or combinations thereof. In some embodiments, the support may be treated to provide varied surface area, porosity, and pH (such as acidic, neutral, or basic pH). Adjustment of these properties may help to tune or optimize performance of the catalyst bed for a particular need. For example, in some embodiments, adjustment of these properties may provide faster or more controlled decomposition of the hydrazine.

In some embodiments, at least a portion of the ammonia in the reaction product of the hydrazine may be provided to an electric thruster 15, which may provide thrust by a process comprising ionization of the ammonia from the reaction product in an electric thruster 15. In some embodiments, the electric thruster 15 may be configured to receive ammonia from the convertor 10. In some embodiments, the convertor 10 includes a storage vessel to store the decomposed hydrazine, predominantly ammonia, at an elevated pressure for subsequent use as the fuel for the electric thruster 15. In some embodiments, one or more conduits, pipes, valves, lumens, channels, tubes, ducts, flex lines, injectors, or the like, are provided for delivering ammonia from the convertor to the electric thruster.

In some embodiments, the electric thruster 15 may enable a process comprising ionization of the ammonia. The ammonia may be ionized by any means effective to ionize ammonia such as a constant or variable electromagnetic field and/or electromagnetic waves created by, for example, an RF source or electric potential difference. Exposure to, for example, electromagnetic waves causes the electrons of the ammonia to accelerate and the ammonia to ionize. The ionized ammonia may comprise any ionic species based on ammonia such as NH₂⁻, HN²⁻, NH₃⁺, NH₃²⁺, NH₄⁺, etc. In some embodiments, other ionic species may be present, such as those related to ionization of other hydrazine decomposition products including, but not limited to, N₂ and/or H₂. Examples of additional ionic species may include, but are not limited to, H₂⁺, H⁺, H⁻, N₂⁺, N₂²⁺, N₂⁻, N₂²⁻, etc. In some embodiments, the ionization provides positive ions such as NH₃⁺, NH₃²⁺, NH₄⁺, H₂⁺, H⁺, N₂⁺, N₂²⁺. In some embodiments, the process which provides electric thrust may further comprise accelerating ionized ammonia, such as positive ionized ammonia (e.g. NH₃⁺, NH₃², and/or NH₄⁺), and optionally other cationic species such as H₂⁺, H⁺, N₂⁺, N₂²⁺, etc., out of the thruster. In some embodiments, acceleration of the ionized ammonia and other ions out of the thruster may be accomplished or assisted by providing an electric potential between at least two grid elements, or electrodes, at an exit plane end of the electric thruster 15. In some embodiments, the electric thruster 15 may utilize a helicon plasma generator as part of the electric thruster configuration.

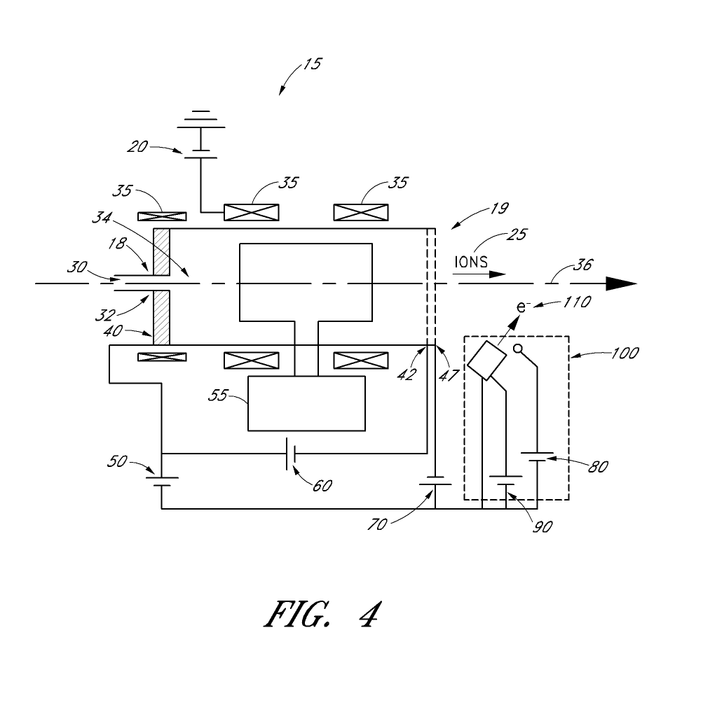

Some embodiments of the electric thruster 15 may be illustrated by the schematic provided in FIG. 4. Components represented in FIG. 4 may be optional. Further, additional components may be present in some embodiments. In some embodiments, the electric thruster 15 comprises a discharge chamber 34 having a proximal end 18 and a distal end 19, wherein the ammonia 30 is provided to the thruster through the proximal end 18, and ions 25, such as ions resulting from ionizing ammonia, are accelerated out of the thruster through the distal end 19. The discharge chamber 34 may be cylindrical in shape about a longitudinal axis 36, or thrust axis, of the electric thruster 15. However, the discharge chamber 34 can be other shapes, as well. The discharge chamber 34 can be sized for a wide variety of thrust loads. Thus the discharge chamber 34 in some embodiments can vary from about 0.01 m to about 1 m in diameter, and about 0.01 m to about 0.5 m in length.

The electric thruster 15 can comprise a helicon plasma generator, which ionizes a gas by projecting a helicon wave through the gas along an axial magnetic field. The electric thruster 15 further comprises an anode 40 adjacent the proximal end 18 that interacts with at least one magnet 35 peripheral to the discharge chamber 34, an RF source 55 (comprising, for example, a radio amplifier, matching network, and antenna), and the ammonia 30 that enters through an inlet 32 at distal end 18. The magnet(s) 35 generates a magnetic field generally parallel to the longitudinal axis, or the centerline, of the electric thruster 15. The interaction of the ammonia 30 with the RF source 55 and, in some instances, the magnet(s) 35, may create a plasma comprising ions of ammonia and other hydrazine decomposition products. The RF antenna, may be coiled, or wrapped, to form a coiled antenna around the outside of the discharge chamber. However, the RF antenna may also comprise, for example, a double saddle coil antenna, or a helical coil antenna disposed about the discharge chamber 34.

The helicon source is an efficient plasma source, and can target the ammonia for ionization by adjusting the RF source 55 power and frequency, and the magnetic field parameters of the magnet(s) 35. Adjusting these parameters allows for increasing or maximizing the collisional cross section on the ammonia by shaping the electron energy distribution function (EEDF). The adjustments can provide for variation in the ammonia ionization and plasma generation results, variation that can be controlled to meet required design parameters. In some embodiments, the ammonia and other decomposition products of hydrazine may be ionized using an RF source 55 having a power of about 0.1 to about 10 kW. Additionally, the RF source may provide a frequency of about 0.01 MHz to about 100 MHz to the plasma.

In particular, the RF source 55 may energize the ammonia 30 gas, such as ammonia produced by decomposition of hydrazine, to ionize and form plasma, thus creating a helicon plasma source. In some embodiments, the magnet(s) 35 may contribute to the ionization of the ammonia. The helicon wave can be produced by the radio-frequency power from the antenna interacting with the plasma in a magnetic field of an appropriate strength established by the magnet(s) 35. The RF energy may also couple into the plasma via inductive coupling.

The magnet(s) 35 can also function to generally confine the electrons so that substantially only the ammonia 30 ions may escape the thruster through the distal end 19. The magnet 35 can comprise in some embodiments, for example, coil windings coupled to the magnet supply 20, or permanent rare-earth magnets. In some embodiments, the magnet 35 may be a coaxial solenoid winding that is wrapped around the discharge chamber 34 to form magnetic fields within the chamber 34, and is powered by a magnet supply 20. The magnet supply 20 may use a power source of, for example, about 1 A to about 200 A. The electric thruster 15 may further comprise an anode 40 at the proximal end 18 to propel cations toward the distal end of the thruster 19. In some embodiments, the potential for the anode may be provided by a discharge supply 50.

The distal end 19 of the electric thruster 15 may further comprise gridded electrodes, such as a screen grid 42 with a positive potential and an accelerator grid 47 with a negative potential, wherein the screen grid 42 is located nearer to the proximal end 19 than the accelerator grid 47. Thrust is provided by accelerating cations such as NH₃⁺, NH₃²⁺, NH₄⁺, H₂⁺, H⁺, N₂⁺, N₂²⁺, etc., from the screen grid 42 to the accelerator grid 47 and out of the electric thruster from the distal end 19 of the electric thruster. The electrodes, otherwise known as an ion extraction assembly, create a plurality of beams of thrust as they pass through the plurality of grid openings. The screen grid 42 and the accelerator grid 47 can be fabricated from any material compatible with the hydrazine reaction products and elevated temperatures and pressures present in the discharge chamber 34, e.g. molybdenum, tantalum, tungsten, a carbon-carbon composite material, or the like.

The screen grid 42 and the accelerator grid 47 can comprise a plurality of apertures that are generally coaxial to each other between the two grids in an assembled electric thruster 15 condition. The apertures can be any shape, e.g., round, and extend through the full thickness of the screen grid 42 and the accelerator grid 47. The cross-sectional size of the aperture, e.g. the diameter, can be the same or either the screen grid 42 or the accelerator grid 47 can have a larger/smaller cross-sectional size as the design application might require. The generally coaxial apertures thus create a stream of ion jets that collectively are referred to as an ion beam, which provides the thrust for the electric thruster 15. The screen grid 42 and the accelerator grid 47 may be generally closely spaced apart, separated by a distance of 0.01 inches to 1.0 inches.

In some embodiments, the screen grid 42 may be powered by a screen grid supply 60 (although the potential applied to the screen grid is positive, it may be less than the potential applied to the anode, as illustrated in FIG. 4) and the accelerator grid 47 may be powered by an accelerator grid supply 70. The velocity of the exiting cations is determined by the difference in potential between the screen grid 42 and the accelerator grid 47. The greater the potential difference, the greater the exit velocity of the cations. In some embodiments, a cathode 100, or neutralizer, may provide electrons 110 to the exhaust, which may provide substantial electrical neutrality to the thruster and the exhaust. Thrust is created by the positive ions that are accelerated through the series of gridded electrodes at the distal end 19 of the thrust chamber. The emitted electrons 110 from the neutralizer, or cathode 100, prevent the highly focused positive ion beams from being electrically attracted back to the thruster or the payload and avoid negatively charging the thruster/payload. The potential for the cathode 100 may be provided by a cathode supply 80.

The cathode supply 80 may generate the voltage required to extract electrons out of the cathode 100 body. The heater supply 90 may deliver the energy required to heat the working material of the cathode 100. (The elevated temperature may reduce the electron work function of the cathode material.)

The electric thruster 15 may be fabricated from materials compatible with hydrazine decomposition products such as ammonia, hydrogen, and nitrogen, and may be capable of withstanding the temperatures, pressures, and thrust loads exerted on the thruster during its operational life cycle. The materials may comprise high strength metallics, e.g. titanium, stainless steel, superalloys, quartz, Pyrex, or the like.

### EXAMPLE 1

A Silica-Nickel nanoparticle, that may be useful as a nanoparticle for a catalyst in components such as a convertor, was prepared as follows. Nickel(II) chloride (0.325 g, 2.5 mmol) and solid sodium hydroxide (0.36 g, 9.00 mmol) were dissolved in ethylene glycol (125 mL) at 60° C. The desired amount of silica was added (for example, 1.32 g 75-200 μm, 150 Å pores for 10% loading). Hydrazine monohydrate (1.5 mL, 30.9 mmol) was added dropwise. The reaction mixture was stirred at 60° C. for 1 hour. After being cooled to room temperature, the stirring was continued overnight (overhead mechanical stirrer). The reaction mixture was diluted with 125 mL of ethanol. The solid product was then collected by centrifuge, washed with cold ethanol (3×40 mL), and dried under vacuum and heat (100° C.). The final Nickel supported on silica is a dark grey powder (at this nickel loading).

Embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. In addition, the foregoing embodiments have been described at a level of detail to allow one of ordinary skill in the art to make and use the devices, systems, etc. described herein. A wide variety of variation is possible. Components, elements, and/or steps may be altered, added, removed, or rearranged.

The foregoing disclosure has partitioned devices and systems into multiple components or modules for ease of explanation. It is to be understood, however, that one or more components or modules may operate as a single unit. Conversely, a single component or module may comprise one or more sub-components or sub-modules.

One or more hardware and/or software controllers can be included for controlling the devices and systems described herein. A hardware controller may be implemented, for example, as a general purpose processor, or as a dedicated processor, such as an Application Specific Integrated Circuit. In the case of a controller that is implemented using software, the software can include one or more modules that include computer-executable code for performing the functions described herein. Such computer-executable code can be stored, for example, in a non-transitory medium, such as computer memory (e.g., ROM or RAM), a hard disk drive, a CD, a DVD, etc.

While certain embodiments have been explicitly described, other embodiments will become apparent to those of ordinary skill in the art based on this disclosure. Therefore, the scope of the invention is intended to be defined by reference to the claims and not simply with regard to the explicitly described embodiments.

What is claimed is:

1. A dual thruster system comprising:
a storage vessel configured to store hydrazine;
a chemical thruster configured to receive hydrazine from the storage vessel and to provide thrust by a reaction of the hydrazine;
a convertor configured to receive hydrazine from the storage vessel, wherein the converter is further configured to catalytically convert hydrazine to a product comprising ammonia; and
an electric thruster configured to receive ammonia from the convertor, and to provide thrust by ionizing the ammonia and accelerating the ionized ammonia out of the electric thruster.

2. The dual thruster system of claim 1, wherein the chemical thruster comprises a catalyst, wherein the chemical thruster is further configured to provide thrust by exothermically and catalytically decomposing the hydrazine.

3. The dual thruster system of claim 1, wherein the chemical thruster is configured to provide thrust by reacting a mixture comprising hydrazine and an oxidizer.

4. The dual thruster system of claim 1, wherein the convertor comprises a plurality of metallic nanoparticles.

5. The dual thruster system of claim 4, wherein the metallic nanoparticles of the convertor comprise at least one of nickel, copper, and iron.

6. The dual thruster system of claim 1, wherein the convertor comprises a plurality of silica-nickel nanoparticles.

7. The dual thruster system of claim 1, wherein the electric thruster comprises a proximal end and a distal end, wherein the ammonia is provided to the electric thruster through the proximal end, and the ionized ammonia is accelerated out of the electric thruster through the distal end.

8. The dual thruster system of claim 1, wherein the ammonia is converted to ammonia ions by exposing the ammonia to an RF source.

9. The dual thruster system of claim 8, wherein the electric thruster further comprises at least one magnet to at least partially confine electrons so that substantially the ionized ammonia only may escape the electric thruster through the distal end.

10. The dual thruster system of claim 1, wherein the electric thruster further comprises an anode at the proximal end to propel the ionized ammonia toward the distal end of the electric thruster.

11. The dual thruster system of claim 1, wherein the distal end of the electric thruster further comprises a screen grid with a positive potential and an accelerator grid with a negative potential, wherein the screen grid is located nearer to the proximal end than to the accelerator grid, and thrust is provided by accelerating the ammonia ions from the screen grid to the accelerator grid and out of the electric thruster from the distal end of the electric thruster.

12. The dual thruster system of claim 1, wherein the ionized ammonia comprises NH₃⁺, NH₃²⁺, or NH₄⁺.

13. A method of providing both chemical and electric propulsion to a dual mode rocket thruster system comprising:
providing chemical propulsion by a reaction of hydrazine; and
providing electric propulsion by a process comprising
catalytically converting hydrazine to a reaction product comprising ammonia,
ionizing the product comprising ammonia, and
providing an electric field to provide thrust by accelerating the ionized reaction product from the electric thruster.

14. The method of claim 13, further comprising converting hydrazine to a reaction product comprising ammonia using a catalyst comprising a plurality of metallic nanoparticles.

15. The method of claim 14, wherein the metallic nanoparticles comprise at least one of nickel, copper, and iron.

16. The method of claim 13, further comprising converting hydrazine to a reaction product comprising ammonia using a catalyst comprising a plurality of silica-metal nanoparticles.

17. The method of claim 16, wherein the metal comprises nickel.

18. The method of claim 13, further comprising converting the ammonia to ammonia ions by exposing the ammonia to an RF source.

19. The method of claim 13, wherein the ionized reaction product comprises NH₃⁺, NH₃²⁺, or NH₄⁺.
